(19) United States
(12) Patent Application Publication
(10) Pub. No.: US 2015/0170651 A1
(43) Pub. Date: Jun. 18, 2015

(54) REMEDYING DISTORTIONS IN SPEECH AUDIOS RECEIVED BY PARTICIPANTS IN CONFERENCE CALLS USING VOICE OVER INTERNET (VOIP)

(71) Applicant: INTERNATIONAL BUSINESS MACHINES CORPORATION, Armonk, NY (US)

(72) Inventors: Robert Thomas Arenburg, Round Rock, TX (US); Franck Barillaud, Austin, TX (US); Shivanth Dutta, Round Rock, TX (US); Alfredo V. Mendoza, Georgetown, TX (US)

(73) Assignee: INTERNATIONAL BUSINESS MACHINES CORPORATION, Armonk, NY (US)

(21) Appl. No.: 14/104,167

(22) Filed: Dec. 12, 2013

(51) Int. Cl. G10L 15/26; H04L 29/06; G10L 15/20

(52) U.S. Cl. CPC G10L 15/265; G10L 15/20; H04L 65/403

(57) ABSTRACT

In a VOIP teleconference, the conference is monitored for speech distortion in either received or transmitted audio speech. Responsive to such distortion, a voice to text conversion is displayed on appropriate receiving terminals only for the time period of the audio speech distortion.

### TECHNICAL FIELD

The present invention relates to computer controlled implementations for telephone and like audio speech conferences between a plurality of participants using Voice Over Internet Protocols (VOIPs), and particularly for remedying distortions in speech received by individual and collective participants.

### BACKGROUND OF RELATED ART

With the globalization of business, industry and trade wherein transactions and activities within these fields have been changing from localized organizations to diverse transactions over the face of the world, the telecommunications industries have been expanding rapidly. This was, of course, accelerated by the rapid expansion of the World Wide Web (Web), which gave rise to Voice Over Internet Protocol (VOIP) telecommunications wherein voice and other audio telecommunications are transmitted over the Internet. In addition, restrictions on travel, as well as attempts at energy conservation have made teleconferencing more attractive.

With this expansion of telephone channels, conferences and conversations throughout the world involving a plurality of participants has become part of the daily routine in most business, educational and governmental institutions. However in view of language, cultural and time differences, participants frequently find such conferences and conversations difficult to clearly achieve the purposes of the participants. As a result, the telecommunications industry is seeking implementations for making telephone conversations and conferences easier on the participants.

A further result of globalization is that there are likely to be a variety of different dialects and accents from the various participants in the common language selected for the conference, e.g. if English, not everyone is fluent in “the King's English”.

Accordingly, when there occurs, in received, i.e. heard speech audio, speech distortion caused by system aberrations, considerable confusion can readily result. Not only is the speech garbled but the participants hearing the distortions may not be able to distinguish whether there is a reception error or whether the lack of clarity is due to their limited capability in the language or even whether it is due to the speaker's limitations in the language.

### SUMMARY OF THE PRESENT INVENTION

The present invention provides an implementation for the handling of distortions in the speech audios received by conference call center participants in VOIP conferences. The invention remedies the distortions and limits any confusion caused by temporary distortion in speech audio received by VOIP conference participants.

Accordingly, the invention provides an implementation for conducting telecommunication conferences between a plurality of participants over a VOIP with each participant respectively connected through a respective one of a corresponding plurality of display terminals. The implementation includes transmitting a speech audio from each display terminal to each other display terminal on the Internet through a central call distribution hub and conducting a speech to text conversion of each speech audio.

One determination is made as to whether a speech audio transmitted from one of said display terminals has distortions and, if the transmitted speech audio has distortions, there is commenced a display of the text conversion representing the distorted speech audio on all of the other display terminals together with the received speech audio.

There is another determination made as to whether a speech audio received by one of said display terminals has distortions and, if the received speech audio has distortions, there is commenced a display of the text representing the distorted speech only on the display terminal receiving the audio having distortions together with the received speech audio.

In accordance with a further aspect of the present invention, a determination is made as to whether the distortions in a speech audio have ended and, if the distortions have ended, then the display of the text on the display terminals that were receiving the audio distortions is terminated.

As will be herein described in greater detail a specific routine is provided to determine if a received speech audio received at one of said display terminals has distortions. There is associated with each receiving display terminal a routine that includes determining if a speech audio received by the display terminal has distortion. Then, responsive to such a received speech audio distortion, there is displayed text representing the distorted speech on only the display terminal receiving the distorted speech audio together with the received speech audio.

The determining if a speech audio transmitted from one of the display terminals has distortions is controlled by a routine associated with the central call distribution hub (call center). The routine comprises determining if an audio transmitted from one of the display terminals has distortion and, responsive to such an audio speech distortion, displays text representing said distorted speech on all of the other display terminals together with the received speech audio.

In accordance with a more particular aspect of this invention, the determining if a speech audio transmitted from one of said display terminals has distortions is carried out by comparing the text conversion representing the text being transmitted to the central call distribution hub from said display terminal for synchronization with text conversion being received at the central control hub.

In accordance with another particular aspect of this invention, determining if a speech audio received by one of said display terminals has distortions is carried out by comparing the text conversion representing the text being transmitted from the call center for synchronization with text conversion being received at the display terminal.

In accordance with another aspect of the invention, if any participant at a receiving display terminal hears distorted speech audio, that participant is enabled to manually turn on the display of text representing said distorted speech on the participant's display terminal.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of a portion of a VOIP telecommunications network on which the present invention may be implemented;

FIG. 2 is a block diagram of a generalized display computer system including a processor unit that may perform the functions of the display terminal computers through which VOIP telecommunications may be carried out in the practice of the present invention, as well for the call center computers;

FIG. 3 is an illustrative flowchart describing the setting up of the process of the present invention for the detection and handling of audio speech distortions in VOIP teleconferencing; and

FIG. 4 is a flowchart of an illustrative run of the process setup in FIG. 3.

### DETAILED DESCRIPTION OF THE PREFERRED EMBODIMENT

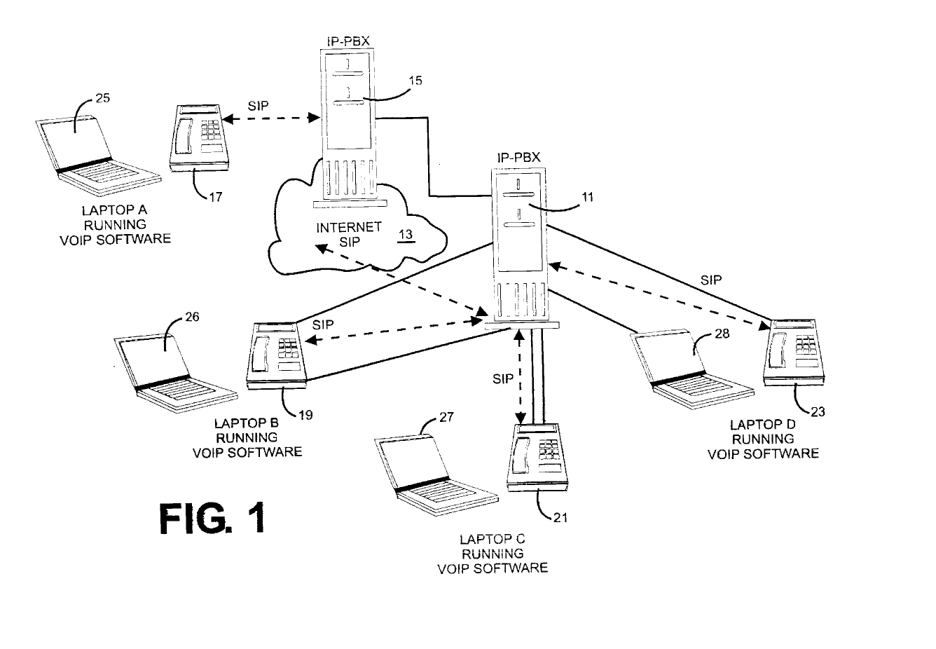

Referring to FIG. 1, there is illustrated a generalized view of an interconnected portion of a VOIP telephone conference environment involving transmissions over the Internet 13 to illustrate the invention through a telephone conference involving telephones 17, 19, 21 and 23 interconnected via the call center 15 and through their respective display computer Internet terminals 25 through 28. The teleconference session shown in FIG. 1 is an industry standard Session Initiation Protocol (SIP) conference wherein the conference participants at terminals 25 through 28 respectively transmit and receive via the Internet and intermediate SIP enabled IP-PBX units 11 and 15, either or both may serve as call centers. For purposes of this description, we will consider IP-PBX 15 as the call center..

An individual speech to text converter mechanism (STM) is associated with each terminal 25 through 28 and with the call center 11 that STMs convert all audio speech to text. Then all audio speech received at any of the terminals 25 through 28 or at the call center 11 is converted into text. These individual STMs at terminals 25 through 28 communicate with the STM at the call center to make sure that both the respective terminal and the call center are receiving and translating text in the same way. Thus, if a STM at a terminal 25 through 28 transmitting speech audios or a terminal 25 receiving speech has a text conversion that fails to coincide with text conversion of the STM at the calling center, there is a high probability that corruption, i.e. distortion in the transmission or the reception of speech audio transmitted or received by the terminal.

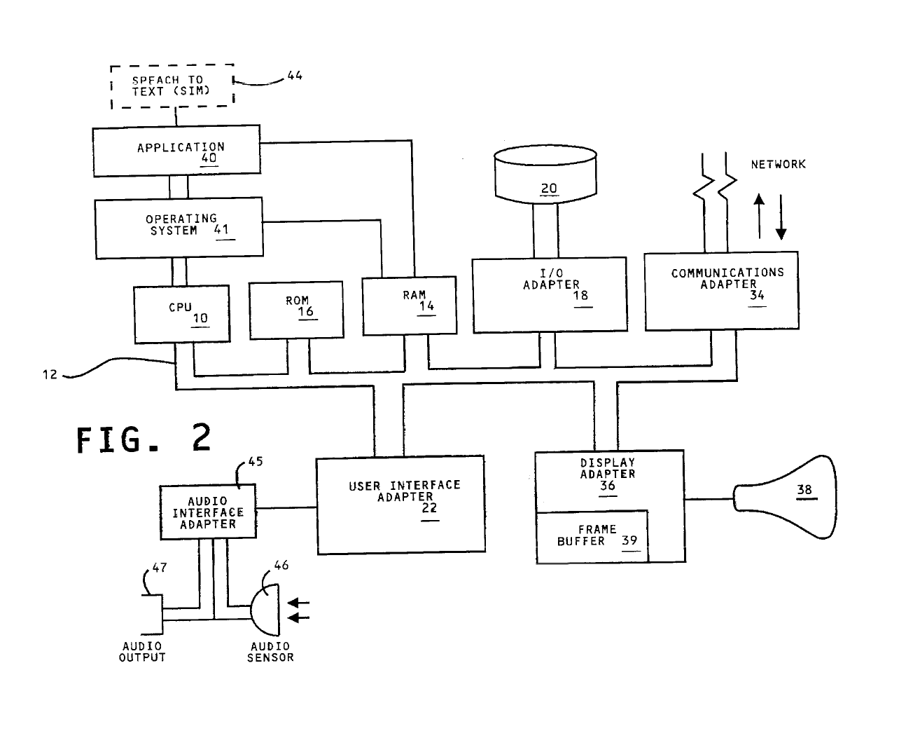

Referring to FIG. 2, a typical data processing system is shown that may function as the Internet display terminals or stations, e.g. terminals 25 through 28 or for call center 11. A central processing unit (CPU) 10 may be one of the commercial microprocessors in personal computers available from International Business Machines Corporation (IBM) or Dell Corporation. The CPU is interconnected to various other components by system bus 12. An operating system 41 runs on CPU 10, provides control and is used to coordinate the function of the various components of FIG. 2. Operating system 41 may be one of the commercially available operating systems. Application programs 40, controlled by the system, are moved into and out of the main memory Random Access Memory (RAM) 14. These programs include the application programs of the present invention for detecting distortions in speech audios between a plurality of participants. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the Internet enabling the computer system to communicate with the other display terminals over the VOIP telecommunications network. I/O devices are also connected to system bus 12 via user interface adapter 22 and display adapter 36, as well as audio adapter 45. It is through such input devices that the user at a display terminal 25 through 28 and call center 11 may interactively relate to the network. Display adapter 36 includes a frame buffer 39 that is a storage device that holds a representation of each pixel on the display screen 38. Images may be stored in frame buffer 39 for display on monitor 38. In the composite system shown in FIG. 2 the audio input, i.e. the conversation, is input through audio sensor 46 and processed through audio input adapter 45. The audio output 47 is similarly processed. These input/output functions for speech audio may be performed on any standard personal computer sound card. The participant's conversation is conventionally processed and output as a VOIP conversation via communications adapter 34. A speech to text application program 44, which may be any of the conventional speech to text conversion applications, is applied to the speech audio for text to speech conversion. Under control of speech to text application 44, the speech audio input of a conference call participant in the telephone conference is converted to text and temporarily stored on disk drive 20. Then, when a speech audio distortion is detected, the speech audio to text conversion is displayed on the appropriate display terminals 25 through 28.

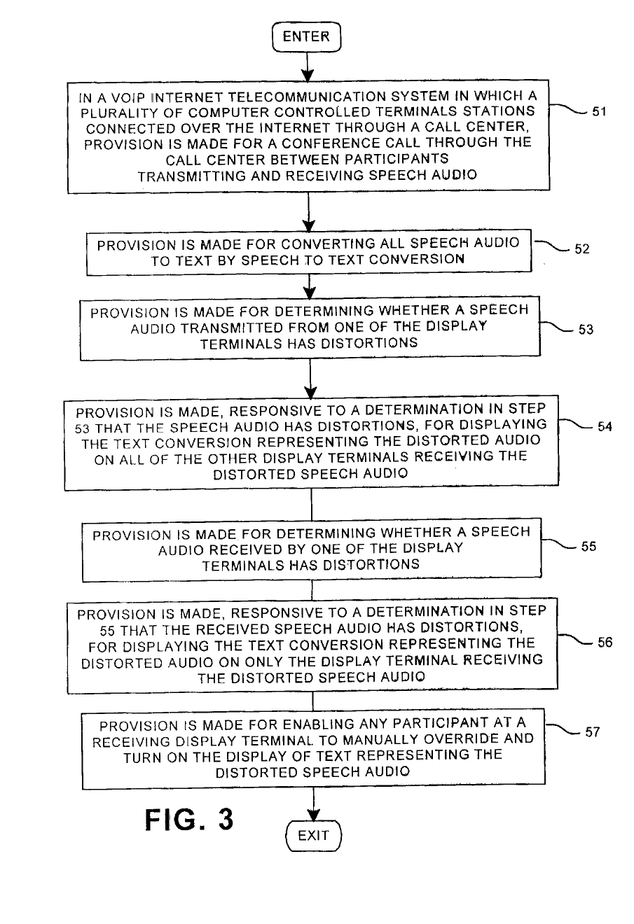

Now, with reference to FIG. 3, we will describe the setting up of a method and computer program according to the present invention for handling speech audio distortions in audio conversations between a plurality of participants in a call conference. In the practice of the invention, there is provided an VOIP telephone network with a plurality of telephones, each having an associated computer controlled display terminal with communication between the participants via speech audio transmitted through a call center, step 51. Initial provision is made for converting all speech audio to text, step 52. Provision is made for determining whether a speech audio transmitted from one of the display terminals has distortions, step 53. Responsive to a determination in step 53 that the transmitted speech audio has distortions, provision is made for displaying the text conversion representing the distorted speech audio on all of the other display terminals receiving the distorted speech audio, step 54.

Provision is then made for determining whether a speech audio received by one of the display terminals has distortions, step 55. Responsive to a determination in step 55 that the received speech audio has distortions, provision is made for displaying the text conversion representing the distorted speech audio on only the display terminal receiving the distorted speech audio, step 56.

Ancillary provision is made for enabling any participant at a receiving display terminal to manually override and turn on the display of text representing the distorted speech audio, step 57.

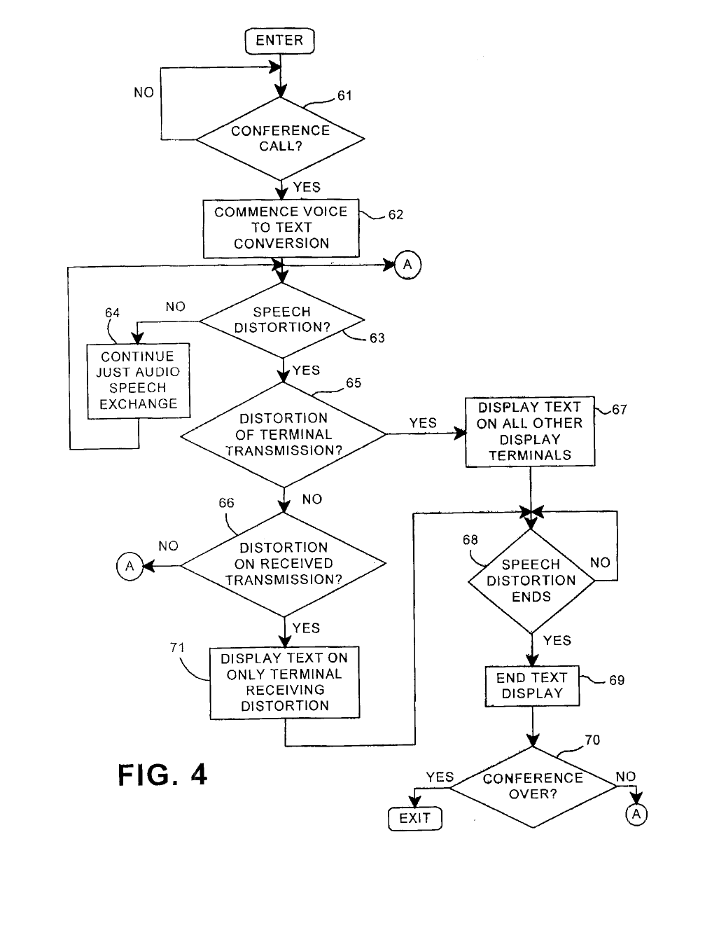

Now that the basic program set up has been described, there will be described with respect to FIG. 4 a flowchart of an operation showing how the program may be run. An initial determination is made as to whether a conference call has begun, step 61. If Yes, the VOIP session according to the present invention is commenced, step 62. A determination is made as to whether any audio speech distortion has been found, step 63. If No, step 64, the session is returned to step 63. If Yes, then a further determination is made, step 65, as to whether the distortion is on audio speech transmitted from one of the terminals in the conference. If Yes, then the text conversion is displayed on all of the other terminals that receive the audio speech, step 67. If the determination in step 65 is No, then a further determination is made, step 66, as to whether the audio speech distortion is on audio speech received on a particular terminal. If No, the session is branched via A back to step 63. If Yes, then, step 71, the voice to text conversion is displayed only on the particular terminal for which the speech distortion has been detected. After steps 67 and 71, a determination is made, step 68, as to whether the audio speech distortion is over. If No, the monitoring in step 68 continues. If Yes, then the display of the text conversion is ended, step 69, and a further determination is made, step 70, as to whether the conference session is over. If Yes, the session is exited. If No, the session is branched via A back to step 63 and the session is continued.

As will be appreciated by one skilled in the art, aspects of the present invention may be embodied as a system, method or computer program product. Accordingly, aspects of the present invention may take the form of an entirely hardware embodiment, an entirely software embodiment, including firmware, resident software, micro-code, etc.; or an embodiment combining software and hardware aspects that may all generally be referred to herein as a “circuit”, “module” or “system.” Furthermore, aspects of the present invention may take the form of a computer program product embodied in one or more computer readable mediums having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared or semiconductor system, apparatus or device, or any suitable combination of the foregoing. More specific examples (a non-exhaustive list) of the computer readable storage medium would include the following: an electrical connection having one or more wires, a portable computer diskette, a hard disk, a Random Access Memory (“RAM”), a Read Only Memory (“ROM”), an Erasable Programmable Read Only Memory (“EPROM” or Flash memory), an optical fiber, a portable compact disc read only memory (“CD-ROM”), an optical storage device, a magnetic storage device or any suitable combination of the foregoing. In the context of this document, a computer readable storage medium may be any tangible medium that can contain or store a program for use by or in connection with an instruction execution system, apparatus or device.

A computer readable medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate or transport a program for use by or in connection with an instruction execution system, apparatus or device.

Program code embodied on a computer readable medium may be transmitted using any appropriate medium, including, but not limited to, wireless, wire line, optical fiber cable, RF, etc., or any suitable combination the foregoing.

Computer program code for carrying out operations for aspects of the present invention may be written in any combination of one or more programming languages, including an object oriented programming language, such as Java, Smalltalk, C++ and the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the later scenario, the remote computer may be connected to the user's computer through any type of network, including a local area network (“LAN”) or a wide area network (“WAN”), or the connection may be made to an external computer (for example, through the Internet, using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer or other programmable data processing apparatus to produce a machine, such that instructions, which execute via the processor of the computer or other programmable data processing apparatus, create means for implementing the functions/acts specified flowchart and/or block diagram block or blocks.

These computer program instructions may also be stored in a computer readable medium that can direct a computer, other programmable data processing apparatus or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagram in the Figures illustrate the architecture, functionality and operations of possible implementations of systems, methods and computer program products according to various embodiments of the present invention. In this regard, each block in the flowchart or block diagrams may represent a module segment, or portion of code, which comprises one or more executable instructions for implementing the specified logical function(s). It should be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams arid/or flowchart illustrations can be implemented by special purpose hardware-based systems that perform the specified functions or acts, or combinations of special purpose hardware and computer instructions.

Although certain preferred embodiments have been shown and described, it will be understood that many changes and modifications may be made therein without departing from the scope and intent of the appended claims.

What is claimed is:

1. A computer controlled display method for conducting telecommunication conferences between a plurality of participants over a Voice Over Internet Protocol (VOIP) each participant respectively connected through a respective one of a corresponding plurality of display terminals comprising:
transmitting a speech audio from each display terminal to each other display terminal on the Internet through a central call center;
conducting a speech to text conversion of each speech audio;
determining if the speech audio transmitted from one of said display terminals has distortions;
if said transmitted speech audio has distortions, commence displaying the text conversion representing said distorted speech audio on all of the other display terminals together with the received speech audio;
determining if a speech audio received by one of said display terminals has distortions; and
if said received speech audio has distortions, displaying the text representing said distorted speech only on the display terminal receiving the audio having distortions together with the received speech audio.

2. The method of claim 1, further including:
determining if said distortions in a speech audio have ended; and
if said distortions have ended, terminating said display of said text on the display terminals now receiving the undistorted speech audio.

3. The method of claim 2, wherein said determining if a received speech audio received at one of said display terminals has distortions is controlled by a routine associated with each receiving display terminal, said routine comprising:
determining if the speech audio received by the display terminal has distortion; and
responsive to such a received speech audio distortion, displaying text representing said distorted speech on only the display terminal receiving the distorted speech audio together with the received speech audio.

4. The method of claim 2, wherein said determining if a speech audio transmitted from one of said display terminals has distortions is controlled by a routine associated with said call center, said routine comprising:
determining if audio transmitted from one of the display terminals has distortion; and
responsive to such an audio speech distortion, displaying text representing said distorted speech on all of the other display terminals together with the received speech audio.

5. The method of claim 1, wherein the step of determining if a speech audio transmitted from one of said display terminals has distortions is carried out by comparing the text conversion representing the text being transmitted to the call center from said display terminal for synchronization with text conversion being received at the call center.

6. The method of claim 1, wherein the step of determining if a speech audio received by one of said display terminals has distortions is carried out by comparing the text conversion representing the text being transmitted from the call center for synchronization with text conversion being received at the display terminal.

7. The method of claim 1, wherein if any participant at a receiving display terminal hears distorted speech audio, enabling the participant to manually turn on the display of text representing said distorted speech on the participant's display terminal.

8. A computer controlled display system for conducting telecommunication conferences between a plurality of participants over a VOIP, each participant respectively connected through a respective one of a corresponding plurality of display terminals, said system comprising:
a processor;
a computer memory holding computer program instructions that, when executed by the processor, perform the method comprising:
transmitting a speech audio from each display terminal to each other display terminal on the Internet through a call center;
conducting a speech to text conversion of each speech audio;
determining if a speech audio transmitted from one of said display terminals has distortions;
if said transmitted speech audio has distortions, commencing displaying the text conversion representing said distorted speech on all of the other display terminals together with the received speech audio;
determining if a speech audio received by one of said display terminals has distortions; and
if said received speech audio has distortions, displaying the text representing said distorted speech only on the display terminal receiving the audio having distortions together with the received speech audio.

9. The system of claim 8, wherein said performed method further includes:
determining if said distortions in a speech audio have ended; and
if said distortions have ended, terminating said display of said text on the display terminals now receiving undistorted speech.

10. The system of claim 9, wherein said determining, in said performed method if a received speech audio received at one of said display terminals has distortions is controlled by a routine associated with each receiving display terminal, said routine comprising:
determining if a speech audio received by the display terminal has distortion; and
responsive to such a received speech audio distortion, displaying text representing said distorted speech on only the display terminal receiving the distorted speech audio together with the received speech audio.

11. The system of claim 9, wherein said determining, in said performed method, if a speech audio transmitted from one of said display terminals has distortions is controlled by a routine associated with said call center, said routine comprising:
determining if audio transmitted from one of the display terminals has distortion; and
responsive to such an audio speech distortion, displaying text representing said distorted speech on all of the other display terminals together with the received speech audio.

12. The system of claim 8, wherein the step, in the performed method, of determining if a speech audio transmitted from one of said display terminals has distortions is carried out by comparing if text conversion representing the text being transmitted to the call center from said display terminal for synchronization with text conversion being received at the call center.

13. The system of claim 8, wherein the step, in the performed method, of determining if a speech audio received by one of said display terminals has distortions is carried out by comparing the text conversion representing the text being transmitted from the call center for synchronization with text conversion being received at the display terminal.

14. The system of claim 8, wherein if any participant at a receiving display terminal hears distorted speech, the performed method enables the participant to manually turn on the display of text representing said distorted speech on the participant's display terminal.

15. A computer usable storage medium having stored thereon a computer readable program for conducting telecommunication conferences between a plurality of participants over a VOIP, each participant respectively connected through a respective one of a corresponding plurality of display terminals, wherein the computer readable program, when executed on a computer, causes the computer to:
transmit a speech audio from each display terminal to each other display terminal on the Internet through a call center;
conduct a speech to text conversion of each speech audio;
determine if a speech audio transmitted from one of said display terminals has distortions;
if said transmitted speech audio has distortions, commence displaying the text conversion representing said distorted speech on all of the other display terminals together with the received speech audio;
determine if a speech audio received by one of said display terminals has distortions; and
if said received speech audio has distortions, display the text representing said distorted speech only on the display terminal receiving the audio having distortions together with the received speech audio.

16. The computer usable storage medium of claim 15, wherein the computer program, when executed, further causes the computer to:
determine if said distortions in a speech audio have ended; and
if said distortions have ended, terminating said display of said text on the display terminals now receiving undistorted speech.

17. The computer usable storage medium of claim 16, wherein when the computer program causes the computer to determine if a received speech audio received at one of said display terminals has distortions, the program causes the computer to carry out a routine associated with each receiving display terminal, said routine causes the computer to:
determine if a speech audio received by the display terminal has distortion; and
responsive to such a received speech audio distortion to display text representing said distorted speech on only the display terminal receiving the distorted speech audio together with the received speech audio.

18. The computer usable storage medium of claim 17, wherein when the computer program causes the computer to determine if a speech audio transmitted from one of said display terminals has distortions, the program causes the computer to carry out a routine associated with said call center, said routine causes the computer to:
determine if audio transmitted from one of the display terminals has distortion; and
responsive to such an audio speech distortion, to display text representing said distorted speech on all of the other display terminals together with the received speech audio.

19. The computer usable storage medium of claim 15 wherein, when the program causes the computer to determine if a speech audio transmitted from one of said display terminals has distortions, the program causes the computer to compare the text conversion representing the text being transmitted to the call center from said display terminal for synchronization with text conversion being received at the call center.

20. The computer usable storage medium of claim 19, wherein the step of determining if a speech audio received by one of said display terminals has distortions is carried out by causing the computer to compare the text conversion representing the text being received by the display terminal for synchronization with text conversion being received at the display terminal.

21. The computer usable medium of claim 15, wherein the program causes the computer to enable any participant at a receiving display terminal who hears distorted auditory speech, to manually turn on the display of text representing said distorted speech on the participant's display terminal.
